(19) United States
(12) Patent Application Publication
(10) Pub. No.: US 2024/0088399 A1
(43) Pub. Date: Mar. 14, 2024

(54) LITHIUM-ION BATTERY ELECTRODE INCLUDING A POROUS CURRENT COLLECTOR

(71) Applicant: GM Global Technology Operations LLC, Detroit, MI (US)

(72) Inventors: Michael P. Balogh, Novi, MI (US); Jiazhi Hu, Troy, MI (US); Jing Gao, Rochester, MI (US); Nicole Ellison, Southfield, MI (US); Ratandeep Singh Kukreja, Auburn Hills, MI (US)

(21) Appl. No.: 17/944,760

(22) Filed: Sep. 14, 2022

(51) Int. Cl. H01M 4/80; H01M 4/04; H01M 4/38; H01M 4/48; H01M 4/525; H01M 4/587; H01M 4/66; H01M 10/0525; H01M 50/434

(52) U.S. Cl. CPC H01M 4/80; H01M 4/0404; H01M 4/382; H01M 4/386; H01M 4/483; H01M 4/525; H01M 4/587; H01M 4/662; H01M 4/663; H01M 10/0525; H01M 50/434; H01M 2004/021

(57) ABSTRACT

A battery electrode for an electrochemical cell that cycles lithium ions is described and includes: a first separator layer including a first side and a second side; a first conductive porous layer located on the first side of the first separator layer; and an active material layer to cycle lithium ions and including a first side and a second side, where the first side of the active material layer is in contact with the first conductive porous layer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries, and more particularly to lithium-ion batteries.

Vehicles with an engine include a battery for starting the engine and supporting accessory loads. Electric vehicles (EVs) such as battery electric vehicles (BEVs), hybrid vehicles, and/or fuel cell vehicles include one or more electric machines and a battery system including one or more battery cells, modules and/or packs to provide propulsion power. A power control system is used to control power to/from the battery system during charging, propulsion and/or regeneration.

Lithium-ion batteries (LIBs) have high power density and are used in EV and non-EV applications. LIBs include anode electrodes, cathode electrodes and separators. The anode electrodes include active material arranged on opposite sides of a current collector. The cathode electrodes include cathode active material arranged on opposite sides of a current collector. The current collectors typically have a thickness in a range from 8 μm to 25 μm.

### SUMMARY

In a feature, a battery electrode for an electrochemical cell that cycles lithium ions is described and includes: a first separator layer including a first side and a second side; a first conductive porous layer located on the first side of the first separator layer; and an active material layer to cycle lithium ions and including a first side and a second side, where the first side of the active material layer is in contact with the first conductive porous layer.

In further features, the active material layer includes anode active material selected from a group consisting of graphite, silicon (Si), lithium oxide (LiOₓ), Li metal or combinations thereof.

In further features, the active material layer includes cathode active material selected from a group consisting of lithium manganese iron phosphate (LMFP), lithium manganese oxide (LMO), nickel manganese cobalt (NMC), nickel manganese cobalt aluminum (NCMA), lithium iron phosphate (LFP), or combinations thereof.

In further features: a second separator layer includes a first side and a second side; and a second conductive porous layer is located on the first side of the second separator layer, where the second side of the active material layer is in contact with the second conductive porous layer.

In further features: the active material layer comprises an anode active material layer, and the active material layer includes one or more conductive porous layers arranged between sublayers of the anode active material layer located between the first side and the second side of the active material layer.

In further features: the active material layer includes an anode active material layer, and the anode active material layer includes: a second separator layer including a first side and a second side; a second conductive porous layer arranged on the first side of the second separator layer; a third conductive porous layer arranged on the second side of the second separator layer; a first anode active material sub-layer arranged on one side of the first conductive porous layer; and a second anode active material sub-layer arranged on one side of the second conductive porous layer.

In further features, the first conductive porous layer includes a material selected from a group consisting of copper (Cu), chromium (Cr), nickel (Ni), titanium (Ti), iron (Fe), carbon (C), aluminum (Al), or combinations thereof.

In further features, the first conductive porous layer has a thickness that is less than, equal to, or greater than 1 μm.

In further features, the active material layer has a thickness in a predetermined range from 10 μm to 100 μm.

In further features, the separator includes silicon dioxide (SiO₂).

In a feature, a method for manufacturing a battery electrode for an electrochemical cell that cycles lithium ions includes: providing a first separator layer including a first side and a second side; forming a first conductive porous layer on the first side of the first separator layer; and coating an active material layer including a first side and a second side on the first conductive porous layer to facilitate cycling of lithium ions.

In further features, the active material layer comprises anode active material selected from a group consisting of graphite, silicon (Si), lithium oxide (LiOₓ), Li metal or combinations thereof.

In further features, the active material layer includes cathode active material selected from a group consisting of lithium manganese iron phosphate (LMFP), lithium manganese oxide (LMO), nickel manganese cobalt (NMC), nickel manganese cobalt aluminum (NCMA), lithium iron phosphate (LFP), or combinations thereof.

In further features, the method further includes: providing a second separator layer including a first side and a second side; forming a second conductive porous layer on the first side of the second separator layer; and arranging the second side of the active material layer in contact with the second conductive porous layer.

In further features: the active material layer includes an anode active material layer, and the active material layer includes one or more conductive porous layers arranged between sublayers of the anode active material layer located between the first side and the second side of the active material layer.

In further features, the active material layer comprises an anode active material layer and where forming the active material layer further includes: providing a second separator layer including a first side and a second side; forming a second conductive porous layer on the first side of the second separator layer; forming a third conductive porous layer on the second side of the second separator layer; forming a first anode active material sub-layer on one side of the first conductive porous layer; and forming a second anode active material sub-layer on one side of the second conductive porous layer.

In further features, the first conductive porous layer includes a material selected from a group consisting of copper (Cu), chromium (Cr), nickel (Ni), titanium (Ti), iron (Fe), carbon (C), aluminum (Al), or combinations thereof.

In further features, the first conductive porous layer has a thickness that is less than, equal to, or greater than 1 μm.

In further features, the active material layer has a thickness in a predetermined range from 10 μm to 100 μm.

In further features, the separator includes silicon dioxide (SiO₂).

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross-sectional view of a battery cell including anode electrodes and cathode electrodes;

FIG. 2 is a side cross-sectional view of an example of a battery cell including anode electrodes and cathode electrodes with porous surface current collectors according to the present disclosure;

FIG. 3 is a side cross-sectional view of another example of a battery cell including anode electrodes and cathode electrodes with porous surface current collectors according to the present disclosure;

FIG. 4 is a side cross-sectional view of another example of a battery cell including anode electrodes and cathode electrodes with porous surface current collectors according to the present disclosure;

FIG. 5 is a side cross-sectional view of another example of a battery cell including anode electrodes and cathode electrodes with porous surface current collectors according to the present disclosure; and

FIG. 6 is a functional block diagram of an example of a process for manufacturing a battery cell according to the present disclosure.

In the drawings, reference numbers may be reused to identify similar and/or identical elements.

### DETAILED DESCRIPTION

While the battery cells are described herein in vehicle applications, the battery cells can be used in other non-vehicle applications.

The battery cells according to the present disclosure includes anode and/or cathode electrodes with internal current collectors replaced by porous current collectors arranged on a surface of the separators. The porous current collectors allow for transport of Li ions.

Mechanical properties and porosity of the porous current collectors are attained by utilizing the separator as a support structure. In some examples, the porous current collectors are formed on outer surfaces of the separators using physical vapor deposition (PVD), electroplating, thermal sintering, additive manufacturing, wet casting, de-alloying, ink-jet printing, electrical sintering, electroless deposition, and/or template-synthesis onto the separator. The electrode active materials are applied directly to the coated separators using current battery manufacturing processes.

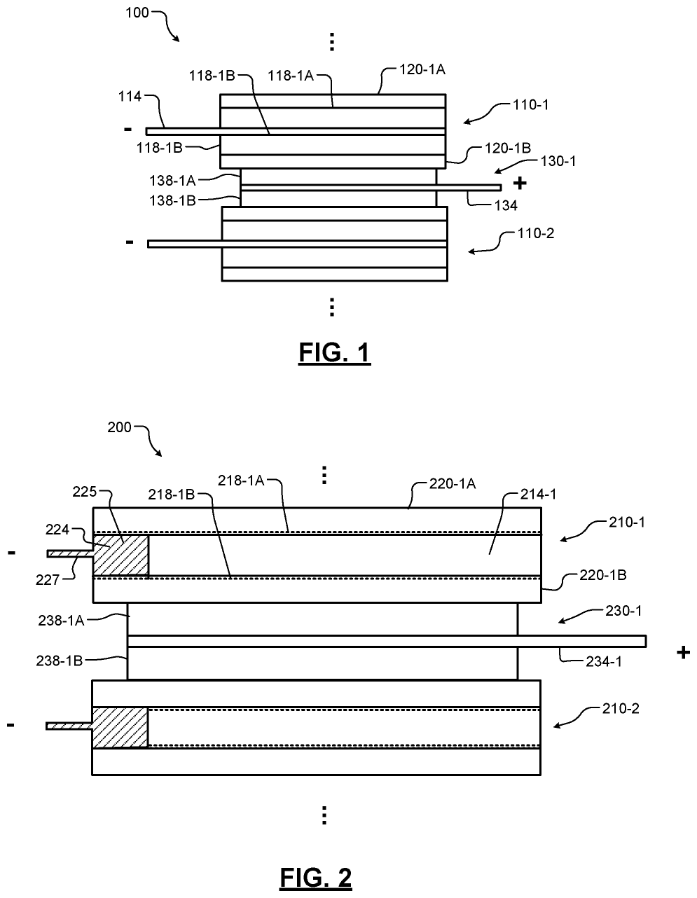

Referring now to FIG. 1, a battery cell 100 includes A anode electrodes 110 (e.g., anode electrodes 110-1 and 110-2 shown) and C cathode electrodes 130 (e.g., cathode electrode 130-1 shown), where A and C are integers greater than one.

The anode electrode 110-1 includes a current collector 114, anode active material 118-1A and 118-1B arranged adjacent to opposite sides of the current collector 114. A separator 120-1A is arranged adjacent to the anode active material 118-1B. A separator 120-1B is arranged on the anode active material 118-1B.

The cathode electrode 130-1 includes a current collector 134 and cathode active material 138-1A and cathode active material 138-1A and 138-1B arranged on opposite sides of the current collector 134. The current collectors 114 and 134 have a predetermined thickness in a range from 8 μm to 25 μm. The thickness of the current collectors 114 and 134 accounts for approximately 10% of the mass, volume, and cost of the LIB. Reducing the thickness of the current collectors 114 and 134 is difficult due to loss of the properties needed for electrode handling.

Referring now to FIG. 2, a battery cell 200 according to the present disclosure includes A anode electrodes 210 (e.g., anode electrodes 210-1 and 210-2 shown) and C cathode electrodes 230 (e.g., cathode electrode 230-1 shown), where A and C are integers greater than one. The A anode electrodes 210 alternate with the C cathode electrodes 230.

The anode electrode 210-1 does not include a current collector of the type shown in FIG. 1. The anode electrode 210-1 includes anode active material layer 214-1 including first and second sides and an external tab 224. In some examples, the external tab 224 includes a first portion 225 that has the same thickness as the anode active material layer 214-1. A second portion 227 extends from and is thinner than the first portion 225. The second portion 227 extends outwardly from the battery cell 200 to allow external connection thereto.

A separator 220-1A includes a porous current collector 218-1A that is arranged on the first side adjacent to one side of the anode active material 214-1. A separator 220-1B includes a porous current collector 218-1B that is arranged on the first side adjacent to the other side of the anode active material 214-1. In other words, the porous current collectors 218-1A and 218-1B are arranged on surfaces of the separator 220-1A and the separator 220-1B facing the anode active material 214-1. The porous current collectors 218-1A and 218-1B are in electrical contact with sides of the external tabs 224-1.

The cathode electrode 230-1 includes a current collector 234-1, cathode active material 238-1A, and cathode active material 238-1B arranged on opposite sides of the current collector 234-1.

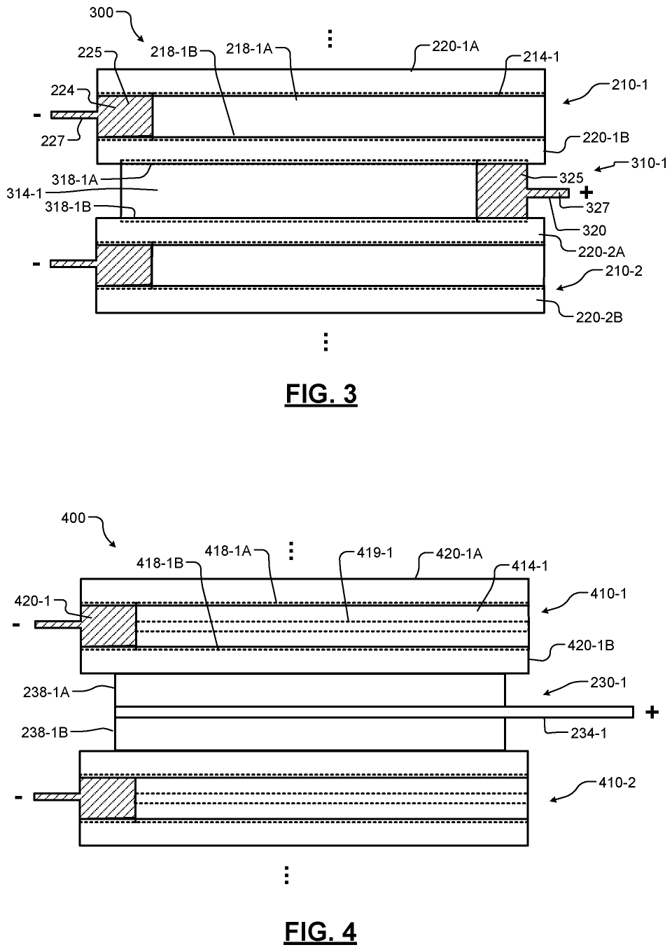

Referring now to FIG. 3, a battery cell 300 includes the A anode electrodes 210 and C cathode electrodes 310 (e.g., cathode electrode 310-1 is shown), where A and C are integers greater than one. In this example, the C cathode electrodes 310 do not include a current collector of the type shown in FIG. 1. The cathode electrode 310-1 includes a cathode active material layer 314-1. Porous current collectors 318-1A and 318-1B are arranged on the separators 220-1A and 220-1B adjacent to opposite sides of the cathode active material layer 314-1. The cathode electrode 310-1 includes an external tab 320. In some examples, the external tab 320 includes a first portion 325 that has the same thickness as the cathode active material layer 314-1 and a second portion 327 that is thinner than the first portion 325 and extends outwardly from the battery cell 300.

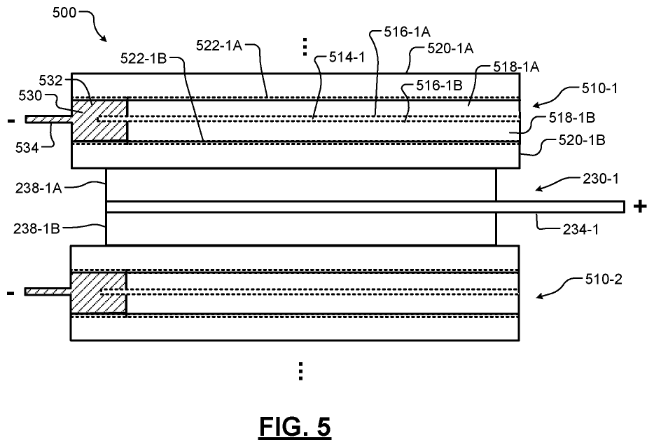

Referring now to FIG. 4, a battery cell 400 includes A anode electrodes 410 (e.g., anode electrodes 410-1 and 410-2 are shown) and the C cathode electrodes 230, where A and C are integers greater than one.

The anode electrode 410-1 includes anode active material 414-1. A separator 420-1A includes a porous current collector 418-1A that is arranged adjacent to one side of the anode active material 414-1. A separator 420-1B includes a porous current collector 418-1B that is arranged adjacent to an opposite side of the anode active material 414-1. In other words, the porous current collectors 418-1A and 418-1B are arranged on surfaces of the separator 220-1A and 220-1B facing the anode active material 414-1. In addition, the anode active material 414-1 includes one or more conductive paths 419-1 (each including a porous conductive layer) arranged in the anode active material 414-1 parallel to and spaced from the porous current collectors 418-1A and 418-1B.

The one or more conductive paths 419-1 can be manufactured by coating a first sub-layer of the anode active material layer 414-1 onto the porous current collector 418-1A, coating the first sub-layer with the porous conductive layer to form a first one of the conductive paths 419-1, coating a second sub-layer of the anode active material layer 414-1, coating the second sub-layer with the porous conductive layer to form a second one of the conductive paths 419-1, coating a third sub-layer of the anode active material layer 414-1, and so on. While two conductive paths 419-1 are shown, one or more can be used.

The cathode electrode 230-1 includes a current collector 234-1, cathode active material 238-1A, and cathode active material 238-1B arranged on opposite sides of the current collector 234-1. Alternatively, a cathode with a porous current collector similar to FIG. 3 can be used. Alternatively, a cathode with a porous current collector similar to FIG. 3 and conductive paths similar to 419-1 can be used.

Referring now to FIG. 5, a battery cell 500 includes A anode electrodes 510 (e.g., anode electrodes 510-1 and 510-2 are shown) and the C cathode electrodes 230, where A and C are integers greater than one.

The battery cell 500 includes an anode electrode 510-1 with a separator layer 514-1 including first and second porous current collectors 516-1 and 516-2 arranged on opposite sides thereof. The anode electrode 510-1 further includes anode active material sub-layers 518-1A and 518-1B are arranged on the porous current collectors 516-1 and 516-2, respectively. Separators 520-1A and 520-1B with porous current collectors 522-1A and 522-1B are arranged on opposite sides of the electrode 510-1.

In some examples, an external tab 530 includes a first portion 532 that has the same thickness as a combined thickness of the anode active material sub-layers 518-1A and 518-1B, the separator layer 514-1, and the porous current collectors 516-1 and 516-2. A second portion 534 is thinner than the first portion 532 and extends outwardly from the battery cell 500 to allow external connection.

The separator 520-1A includes the porous current collector 518-1 on one side thereof that is arranged adjacent to one side of the anode active material 514-1. The separator 520-1B includes the porous current collector 518-1B on one side thereof that is arranged adjacent to an opposite side of the anode active material 514-1. In other words, the porous current collectors 518-1A and 518-1B are arranged on a surface of the separator 520-1A and 520-1B facing the anode active material 514-1. In some examples, the separator 516-1 and the first and second porous current collectors 516-1 and 516-2 are thinner than the separators 520-1A and 520-1B.

The cathode electrode 230-1 includes a current collector 234-1, cathode active material 238-1A, and cathode active material 238-1B arranged on opposite sides of the current collector 234-1. Alternatively, a cathode with a porous current collector similar to FIG. 3 can be used.

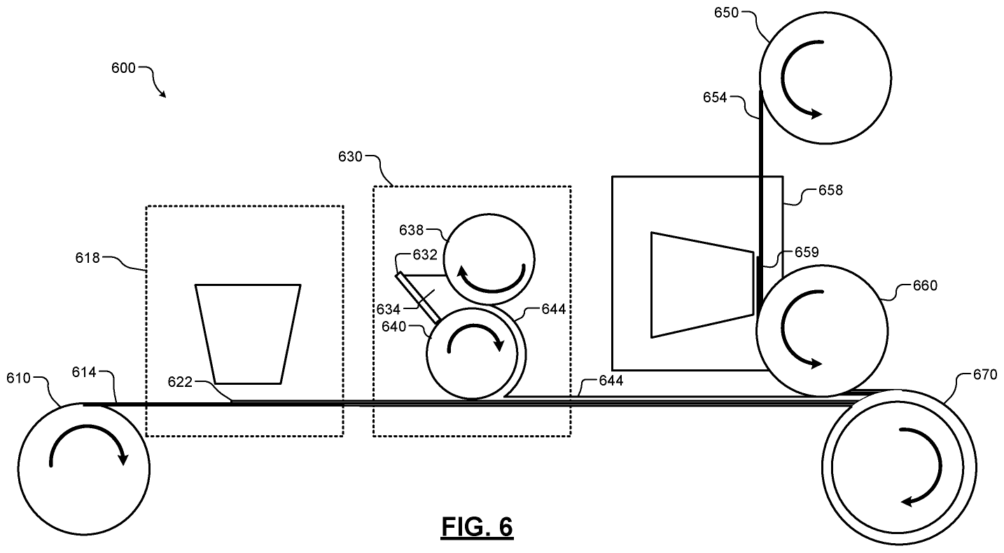

Referring now to FIG. 6, a process for manufacturing a battery cell such as the battery cell 200 is shown. A roll 610 supplies a separator layer 614. A porous metal coater 618 applies a porous current collector layer 622 on the separator layer 614.

In some examples, the external tab is coated, glued, or printed in space locations (corresponding to cell width) on the separator layer 614 prior to coating the anode active material layer. Electrode coater 630 includes rollers 638 and 640 that can apply tension, pressure and/or heat. An active material supply 632 supplies active material 634 between the rollers 638 and 640. An active material layer 644 is added over the porous current collector layer 622 arranged on the separator layer 614.

A roll 650 supplies a separator layer 654 to a porous metal coater 658. The porous metal coater 658 applies a porous current collector layer 659 on the separator layer 654. A roller 660 combines the porous current collector layer 659, the separator layer 654, the active material layer 644, the porous current collector layer 622, and the separator layer 614 as shown in FIG. 1. A roller 670 stores the electrode roll. Other electrodes can be manufactured in a similar manner.

In some examples, the porous surface current collectors and/or the porous conductive paths include a conductive material selected from a group consisting of copper (Cu), chromium (Cr), nickel (Ni), titanium (Ti), iron (Fe), carbon (C), aluminum (Al), or combinations thereof. In some examples, the conductive porous layer has a thickness that is less than 1 μm. In some examples, the conductive porous layer is deposited on the separator using PVD, electroplating, sintering, additive manufacturing, wet casting, de-alloying, ink-jet printing, electrical sintering, electroless deposition and template-synthesis.

In some examples, the anode active material layer is selected from a group consisting of graphite, silicon (Si), lithium oxide (LiOₓ), Li metal, or combinations thereof. In some examples, the active material layer has a thickness in a range from 10 μm to 100 μm. In some examples, the cathode active material layer is selected from a group consisting of lithium manganese iron phosphate (LMFP), lithium manganese oxide (LMO), nickel manganese cobalt (NMC), nickel manganese cobalt aluminum (NCMA), lithium iron phosphate (LFP), or combinations thereof. In some examples, the separator includes silicon dioxide (SiO₂).

In some examples, the cathode or anode active material layer is slurry coated onto the porous conductive layer. In some examples, the cathode or anode active material layer is laminated on the conductive layer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery electrode for an electrochemical cell that cycles lithium ions, comprising:
a first separator layer including a first side and a second side;
a first conductive porous layer located on the first side of the first separator layer; and
an active material layer to cycle lithium ions and including a first side and a second side,
wherein the first side of the active material layer is in contact with the first conductive porous layer.

2. The battery electrode of claim 1, wherein the active material layer comprises anode active material selected from a group consisting of graphite, silicon (Si), lithium oxide (LiOₓ), Li metal or combinations thereof.

3. The battery electrode of claim 1, wherein the active material layer comprises cathode active material selected from a group consisting of lithium manganese iron phosphate (LMFP), lithium manganese oxide (LMO), nickel manganese cobalt (NMC), nickel manganese cobalt aluminum (NCMA), lithium iron phosphate (LFP), or combinations thereof.

4. The battery electrode of claim 1, further comprising:
a second separator layer including a first side and a second side; and
a second conductive porous layer located on the first side of the second separator layer,
wherein the second side of the active material layer is in contact with the second conductive porous layer.

5. The battery electrode of claim 1, wherein:
the active material layer comprises an anode active material layer, and
the active material layer includes one or more conductive porous layers arranged between sublayers of the anode active material layer located between the first side and the second side of the active material layer.

6. The battery electrode of claim 1, wherein:
the active material layer comprises an anode active material layer, and
the anode active material layer includes:
a second separator layer including a first side and a second side;
a second conductive porous layer arranged on the first side of the second separator layer;
a third conductive porous layer arranged on the second side of the second separator layer;
a first anode active material sub-layer arranged on one side of the first conductive porous layer; and
a second anode active material sub-layer arranged on one side of the second conductive porous layer.

7. The battery electrode of claim 1, wherein the first conductive porous layer includes a material selected from a group consisting of copper (Cu), chromium (Cr), nickel (Ni), titanium (Ti), iron (Fe), carbon (C), aluminum (Al), or combinations thereof.

8. The battery electrode of claim 1, wherein the first conductive porous layer has a thickness that is less than, equal to, or greater than 1 μm.

9. The battery electrode of claim 1, wherein the active material layer has a thickness in a predetermined range from 10 μm to 100 μm.

10. The battery electrode of claim 1, wherein the separator includes silicon dioxide (SiO₂).

11. A method for manufacturing a battery electrode for an electrochemical cell that cycles lithium ions, comprising:
providing a first separator layer including a first side and a second side;
forming a first conductive porous layer on the first side of the first separator layer; and
coating an active material layer including a first side and a second side on the first conductive porous layer to facilitate cycling of lithium ions.

12. The method of claim 11, wherein the active material layer comprises anode active material selected from a group consisting of graphite, silicon (Si), lithium oxide (LiOₓ), Li metal or combinations thereof.

13. The method of claim 11, wherein the active material layer comprises cathode active material selected from a group consisting of lithium manganese iron phosphate (LMFP), lithium manganese oxide (LMO), nickel manganese cobalt (NMC), nickel manganese cobalt aluminum (NCMA), lithium iron phosphate (LFP), or combinations thereof.

14. The method of claim 11, further comprising:
providing a second separator layer including a first side and a second side;
forming a second conductive porous layer on the first side of the second separator layer; and
arranging the second side of the active material layer in contact with the second conductive porous layer.

15. The method of claim 11, wherein:
the active material layer comprises an anode active material layer, and
the active material layer includes one or more conductive porous layers arranged between sublayers of the anode active material layer located between the first side and the second side of the active material layer.

16. The method of claim 11, wherein the active material layer comprises an anode active material layer and wherein forming the active material layer further comprises:
providing a second separator layer including a first side and a second side;
forming a second conductive porous layer on the first side of the second separator layer;
forming a third conductive porous layer on the second side of the second separator layer;
forming a first anode active material sub-layer on one side of the first conductive porous layer; and
forming a second anode active material sub-layer on one side of the second conductive porous layer.

17. The method of claim 11, wherein the first conductive porous layer includes a material selected from a group consisting of copper (Cu), chromium (Cr), nickel (Ni), titanium (Ti), iron (Fe), carbon (C), aluminum (Al), or combinations thereof.

18. The method of claim 11, wherein the first conductive porous layer has a thickness that is less than, equal to, or greater than 1 μm.

19. The method of claim 11, wherein the active material layer has a thickness in a predetermined range from 10 μm to 100 μm.

20. The method of claim 11, wherein the separator includes silicon dioxide (SiO₂).
